(19) United States
(12) Patent Application Publication
(10) Pub. No.: US 2005/0007010 A1
(43) Pub. Date: Jan. 13, 2005

(54) Structure of the stem of LED chip unit bulb

(76) Inventor: Han-Ming Lee, Hsin Chu City (TW)

Correspondence Address: Han-Ming Lee, P.O. BOX 7-288, TAIPEI, 106, TW

(21) Appl. No.: 10/620,868

(22) Filed: Jul. 9, 2003

(51) Int. Cl. H01J 1/62

(52) U.S. Cl. 313/498

(57) ABSTRACT

The present invention is related to a new structure of the stem of LED Chip Unit bulb, which comprises a cup disk, a chip, a stand, a molybdenum alloy wire and a stem. Essentially, the brace-end of the stem is connected to a supportive chip cup disk. The center of the disk is concave so as to form a holding chamber whose inner diameter is open, arc-shaped and circular. The molybdenum alloy wire is tapered off to a point and thus it takes a turn of 180°, hooking and pressing against the chip. Given the elastic coefficient of the barb-turning angle, the tip of the molybdenum alloy wire may point-press against the chip in a normal state in response to the temperature-dependent expansion-contraction feature of the chip. The gradient of the arc-shaped, circular wall of the disk enables the chip to generate light that refracts at different angles, giving rise to a wide-angle, open, homogeneous light source. The vacuum inside the bulb facilitates efficient circulation and therefore heat absorption. As a result, despite the heat dissipation of the chip, the temperature of the bulb does not increase, prolonging the life of the bulb. Hence, the new structure of the stem of LED chip unit bulb does have a practical utility.

### BACKGROUND OF THE INVENTION

With regard to a conventional bulb, the stem supports the tungsten filament. The stems have to be manufactured in the following way. Parts like inner tubes, trumpet tubes, inner stems and guiding filaments are processed one by one to produce semi-finished products. Then, tungsten filaments are pressed. Finally, all the parts and the shell of the bulb are sealed by fusion and condensation. The manufacturing process is labor-intensive and it is carried out by more than one workstation. Accordingly, not only is throughput unsatisfactory, but quality control also is seldom easy, leading to a rather high defect rate. Hence, the cost efficiency is low and the contemporary economic requirements are not met. On the other hand, all the aforesaid parts together occupy considerable space of the bulb. Since the glass components contain lead, the illumination of the bulb brings about the evaporation of lead, increasing the temperature of the bulb and therefore shortening the life of the bulb. LED diodes become popular in recent years; the luminescent stand contained in a bulb is made from transparent plastics, thus the inner luminescent layer is subject to a temperature limit. For this reason, the light energy emitted by LED nowadays is quite limited, and the sealed resin will melt and ruin once there is a slight increase in the luminescence intensity or the electricity consumed by the light source.

### SUMMARY OF THE INVENTION

The primary purpose of the present invention is to provide a new structure of the stem of LED chip unit bulb, and particularly the brace-end of the stem being connected to the supportive chip cup disk. The center of the disk is concave so as to form a holding chamber whose inner diameter is open, arc-shaped and circular. The molybdenum alloy wire is tapered off to a point and thus it takes a turn of 180°, hooking and pressing against the chip. As a result, the new structure of the stem of LED chip unit bulb does have a practical utility.

The secondary purpose of the present invention is to provide a new structure of the stem of LED chip unit bulb, so that the tip of the molybdenum alloy wire may point-press against the chip in a normal state in response to the temperature-dependent expansion-contraction feature of the chip, because of the elastic coefficient of the barb-turning angle.

Another purpose of the present invention is to provide a new structure of the stem of LED chip unit bulb, wherein the gradient of the arc-shaped, circular wall of the disk enables the chip to generate light that refracts at different angles, giving rise to a wide-angle, open, homogeneous light source.

An additional purpose of the present invention is to provide a new structure of the stem of LED chip unit bulb, wherein the vacuum inside the bulb facilitates efficient circulation and therefore heat absorption. As a result, despite the heat dissipation of the chip, the temperature of the bulb does not increase, prolonging the life of the bulb.

### BRIEF DESCRIPTION OF THE DRAWINGS

FIG. 1 is a diagram that illustrates the new structure of the stem of LED chip unit bulb put forth by the present invention;

FIG. 2 is a three-dimensional diagram about the constituents of the new structure of the stem of LED chip unit bulb put forth by the present invention;

FIG. 3 depicts the inside of the bulb related to the stem put forth by the present invention;

FIG. 4 is a diagram about the preferred embodiment of the point pressing and wide-angle refraction as designed in the present invention;

FIG. 5 depicts the preferred embodiment of the bulb put forth by the present invention, as opposed to a conventional bulb equipped with tungsten filament.

### DELTAILED DESCRIPTION OF THE PREFERRED EMBODIMENT

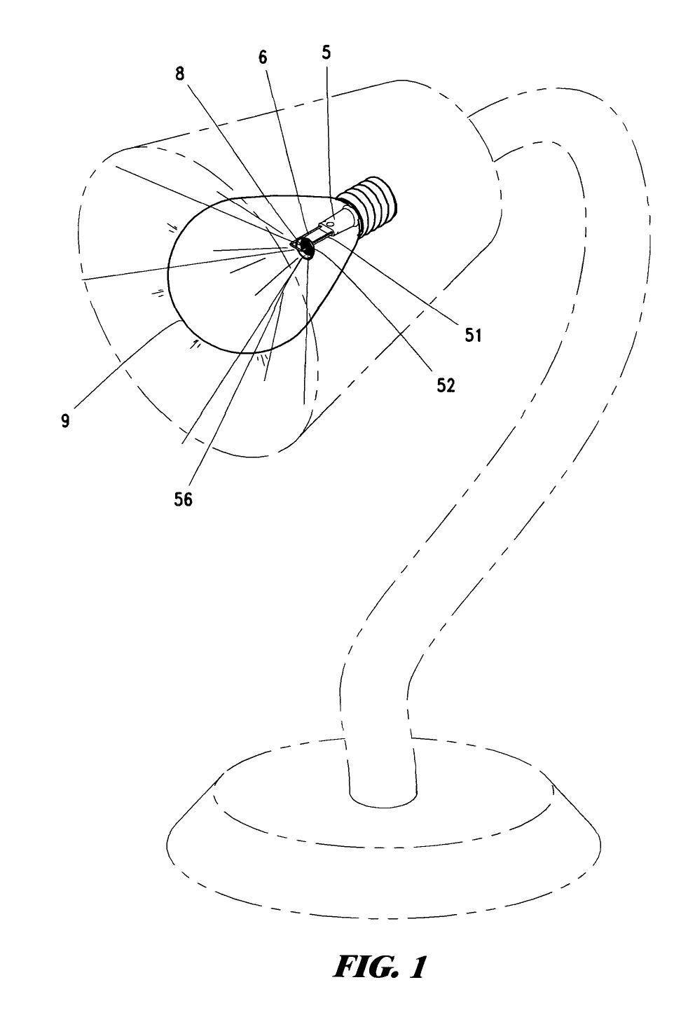

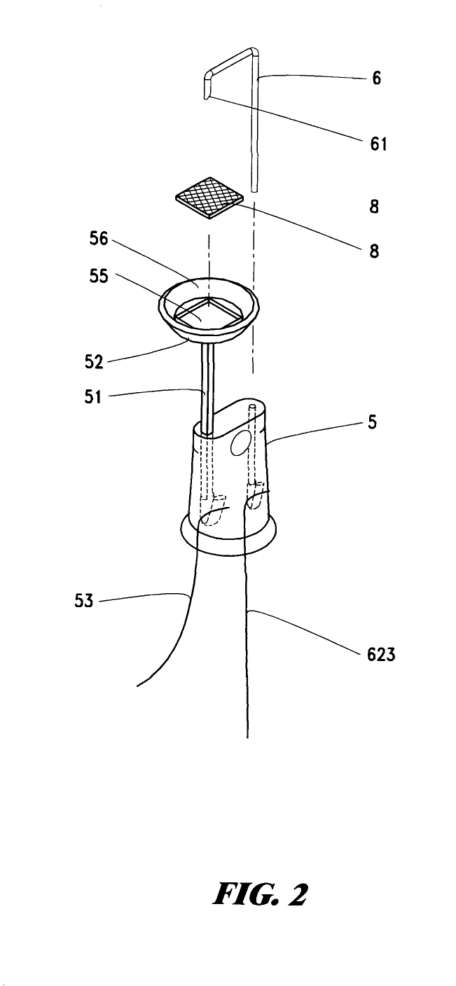

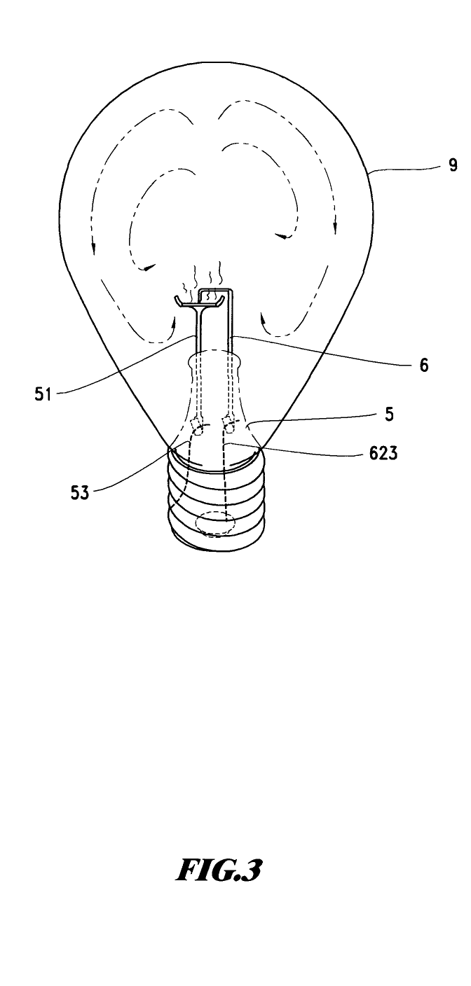

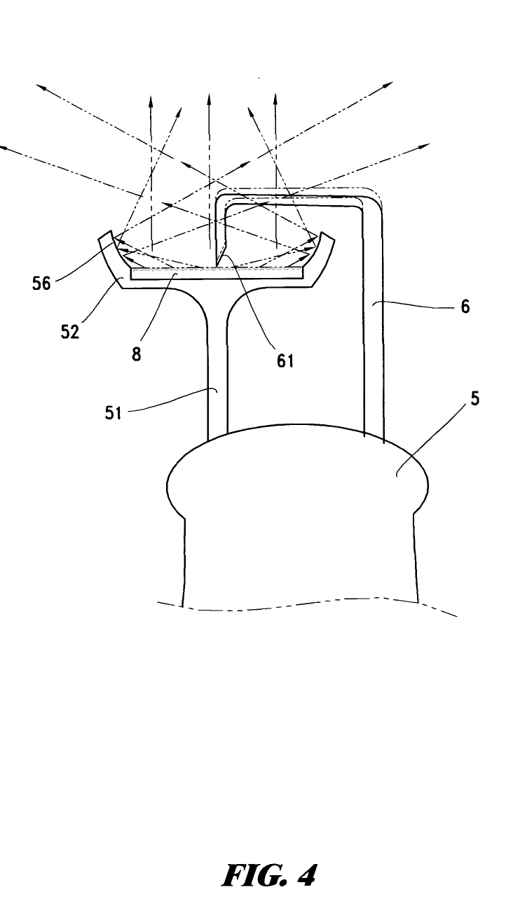

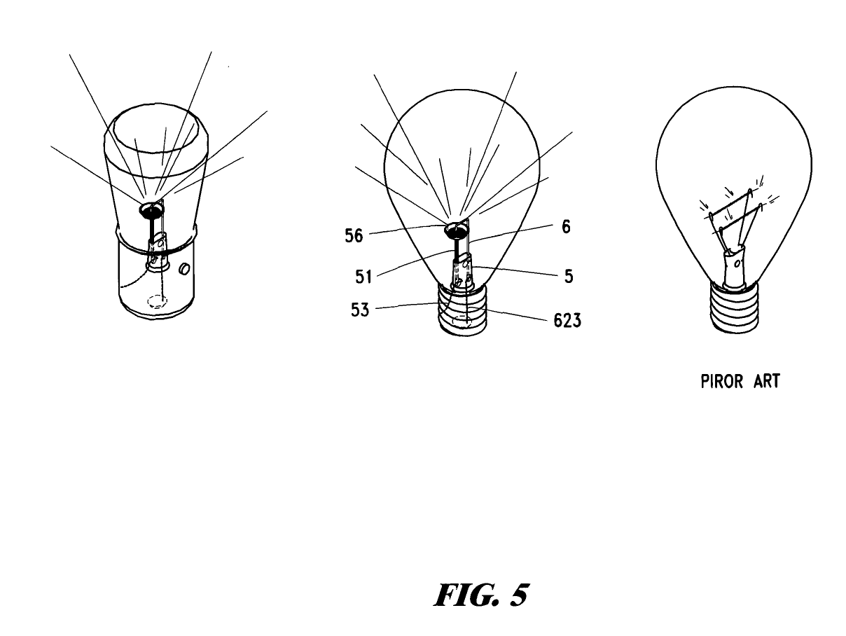

As shown in FIGS. 1-5, the present invention is about the new structure of the stem of LED chip unit bulb that comprise a cup disk, a chip, a stand, a molybdenum alloy wire and a stem. Essentially, the stem 5 condenses and connects the upper end of the support 51 and the supportive chip unit disk 52. The lower end of the stand presses against the rivet 53 so that it extends beyond the stem body to be connected to the cathode power. The center of the disk is concave so as to form a holding chamber 55 whose inner diameter is open, arc-shaped and circular. The arc-shaped slope 56 of the inner circumference of the disk has circular groove pointing toward the upward, open cathode disk. The stem support is equipped with a molybdenum alloy wire 6 whose end is tapered off to form the tip 61, taking a 180° turn at an appropriate location, so that the tip hooks and presses against the surface of chip 8 and therefore enables electric conduction. The lower end of the molybdenum alloy wire is connected to the magnesium-plated wire 623 and it sticks out of the stem body to be connected to the anode power. The constituents of the present invention function in such a way that, when the chip emits light energy, the tip of the molybdenum alloy wire may point-press against the chip in a normal state in response to the temperature-dependent expansion feature or contraction (non-illumination) feature of the chip, because of the elastic coefficient of the 180° barb-turning angle of the molybdenum alloy wire. Besides, the gradient of the arc-shaped, circular wall of the disk enables the chip to generate light that refracts at different angles, giving rise to a wide-angle, open, homogeneous light source. Since air was drawn out of the bulb 9, the vacuum inside the bulb facilitates efficient circulation and therefore heat absorption. As a result, despite the heat dissipation of the chip, the temperature of the bulb does not increase, prolonging the life of the bulb. Hence, the new structure of the stem of LED chip unit bulb does have a practical utility.

1. A new structure of the stem of LED chip unit bulb, which comprises a cup disk, a chip, a stand, a molybdenum alloy wire and a stem; essentially,
the brace-end of the stem being connected to the supportive chip cup disk; the center of the disk is concave so as to form a holding chamber whose inner diameter is open, arc-shaped and circular; the arc-shaped slope of the inner circumference of the disk has circular groove pointing toward the upward, open cathode disk; and
the stem brace is equipped with a molybdenum alloy wire whose end is tapered off to form the tip, taking a 180° turn at an appropriate location, so that said tip hooks and presses against the surface of chip; since air was drawn out of the bulb, the vacuum inside said bulb facilitates efficient circulation and therefore heat absorption. As a result, despite the heat dissipation of said chip, the temperature of said bulb does not increase, prolonging the life of said bulb.

2. The new structure of the stem of LED chip unit bulb of claim 1, wherein said tip of the molybdenum alloy wire may point-press against said chip in a normal state in response to the temperature-dependent expansion feature or contraction (non-illumination) feature of said chip, because of the elastic coefficient of the barb-turning angle of said molybdenum alloy wire.

3. The new structure of the stem of LED chip unit bulb of claim 1, wherein said gradient of the arc-shaped, circular wall of said disk enables said chip to generate light that refracts at different angles, giving rise to a wide-angle, open, homogeneous light source.
